(19) United States
(12) Patent Application Publication
(10) Pub. No.: US 2022/0235726 A1
(43) Pub. Date: Jul. 28, 2022

(54) ELECTRIC MACHINE, DRIVE SYSTEM, AND USE THEREOF

(71) Applicant: FEAAM GmbH, Neubiberg (DE)

(72) Inventor: Andreas GREIFELT, Munich (DE)

(21) Appl. No.: 17/581,851

(22) Filed: Jan. 21, 2022

(30) Foreign Application Priority Data
Jan. 22, 2021 (DE) 102021101408.5

(51) Int. Cl. F02K 5/00; H02K 16/00; H02K 1/16; H02K 3/12; H02K 1/27

(52) U.S. Cl. CPC F02K 5/00; H02K 16/00; F05D 2260/40; H02K 3/12; H02K 1/27; H02K 1/16

(57) ABSTRACT

The invention relates to an electric machine, comprising a first rotor (1), a second rotor (2), and a common stator (3), wherein the rotors (1, 2) are disposed axially to each other and are set up for different rotary speeds and/or direction of rotation.

The present invention relates to an electric machine, a drive system having an electric machine, and the use of the drive system.

Electric machines can convert electrical energy into mechanical energy or vice versa. Depending on which, said machines work as motors or generators. Electric drives are used in ships and aircraft, for example.

In the area of ship drives, mechanically driven propellers rotating in opposite directions and axially disposed one behind the other are known. A similar principle is also known in aviation, for example with propellers rotating in opposite directions.

In the following, shafts or axles rotating in opposite directions are referred to in general as output units in order to avoid limiting to only one or a few applications.

Said known output units running in opposite directions are typically mechanically driven. The reversal of direction of rotation is performed by means of an integrated mechanical gearbox. The geometry of the two output units is thereby typically identical and the rotary speed thereof often is as well.

For example, for ship drives, the two propellers are mounted rotated 1800 relative to each other and have identical inner and outer diameters of the blades, the same number of blades, and identical shape of the blades.

The mechanical reversal of direction of rotation in particular leads to high machinal complexity and high weight.

The object of the invention is to produce an electric machine and a drive system avoiding at least one of the disadvantages named above.

The object is achieved by the subject-matter of the independent claims.

Advantageous embodiments and refinements are disclosed in the dependent claims.

In one embodiment, an electric machine comprises at least two rotors, namely one first rotor and one second rotor. The electric machine further comprises a common stator for both rotors. The rotors are disposed axial to each other. The rotors are set up for different rotary speeds and/or direction of rotation.

The design of the stator, the stator windings, and the rotors can thereby be such that the rotors are set up for different rotary speeds and/or direction of rotation.

In other words, the first and the second rotor can be driven as electric motors such that each has a dedicated rotary speed, preferably not identical to the rotary speed of the other rotor. The rotors can further have a different direction of rotation. To this end, the electric machine is set up accordingly.

No mechanical gearbox is necessary for reversing the direction of rotation between the two rotors. The proposed principle thus allows rotors having different rotary speeds and/or different direction of rotation to be driven and simultaneously achieves significantly reduced mechanical complexity and lower weight.

In comparison with a single rotor, the advantages of higher efficiency, significantly reduced torque on the driven device, and smaller outer diameter for the same power output can be achieved.

In one embodiment, the common stator comprises at least one electrical coil disposed so that the magnetic field thereof is used by both rotors.

In other words, the common stator of the plurality of rotors is defined in the present embodiment such that both rotors are driven by at least one common electrical coil.

The stator comprises at least one tooth-concentrated winding in one embodiment. The at least one tooth-concentrated winding comprises at least one electrical coil.

The stator can thereby comprise grooves between which teeth are formed. A tooth-concentrated winding in the present context means that at least one electrical coil is wound about exactly one tooth of the stator.

In one embodiment, each tooth of the stator is wound about by one coil. The electrical system by means of which the tooth-concentrated winding of the stator is fed can thereby be single-phase or multi-phase, for example three-phase.

In another embodiment, the common stator comprises at least one groove preferably running parallel to the axis of the electric machine. One conductor bar each is placed in said groove, such that the magnetic field thus generated is used by both rotors. The conductor bars can be short-circuited to each other at one end of the stator, for example. At the other end of the stator, for example, one electrical phase can be associated with each conductor bar, wherein the electric feeding of the machine can take place such that an individual current function is provided for each conductor bar, wherein the current functions of the conductor bars are phase-offset from each other, for example.

In one embodiment, the electric machine can be designed such that the magnetomotive force in the air gap between the stator and the rotors has two higher harmonics, of which one is used as a working wave for the first rotor and the other is used as a working wave for the second rotor.

The stator of such an electric machine typically generates not only a magnetic flux wave for producing torque, but also additional waves rotating at different rotary speeds and alternating direction of rotation due to different number of poles. Said property can be utilized such that such a stator is combined with two rotors having identical or different number of poles, so that the magnetic flux waves of said number of poles have different directions of rotation.

In one embodiment, only one control unit is provided and the exciting feed frequency for both magnetic flux waves is therefore identical, so that different rotary speeds result for different numbers of poles.

The common stator can be fed by a single control unit, so that coupled control is not necessary for the two rotors.

For tooth-concentrated windings, the plurality of magnetic flux waves are particularly distinctive.

If, for example, a stator having twelve teeth is selected, wherein each tooth or every second tooth is wound, then the number poles can be between 10 and 14, for example. A relative rotary speed ratio of five to seven can thus be implemented.

In one embodiment, the stator is continuously wound as described above, but a gap is present in the laminated core in order to electromagnetically balance the gap between the rotors. The savings in laminations can reduce costs.

The electric machine can comprise more than two rotors disposed axially to each other.

In one embodiment, the total number of rotors in the electric machine is an even number.

In one embodiment, synchronous rotors are used as rotors.

For example, said synchronous rotors can be implemented as rotors having surface magnets, rotors having buried magnets, synchronous reluctance rotors, externally excited synchronous rotors, or others.

In another embodiment, a drive system is provided and comprises an electric machine as described above. The drive system is intended for use in liquid or gaseous media. The first rotor is thereby mechanically connected to first blades and the second rotor is mechanically connected to second blades.

The pairings of each rotor and the associated blades are also referred to as output units.

The principle described, having two output units and one common stator, can be used advantageously in liquid or gaseous media, for example as a pump drive, compressor drive, wind power generator, drive for watercraft, or drive for aircraft.

The blades of the output units can thereby rotate in opposite directions or at different rotary speeds, or both.

In one embodiment, the first blades are implemented as a propeller or impeller. The second blades are implemented as a propeller or impeller, wherein different types or the same type can be combined with each other for the output units.

In one embodiment, the first blades have a different geometry from the second blades. It is thereby possible to optimize the flow behavior, for example.

In one embodiment, the output unit rotating more slowly is impinged on by the liquid or gaseous medium.

The drive system can comprise a rotationally symmetrical housing in which the drive units are disposed.

The housing can comprise circular openings for the liquid or gaseous medium to flow in and out.

The housing can further comprise a streamlined contour in the axial direction, for example in the form of a Venturi nozzle.

The proposed principle is explained in more detail below using drawings for a plurality of embodiment examples.

They show:

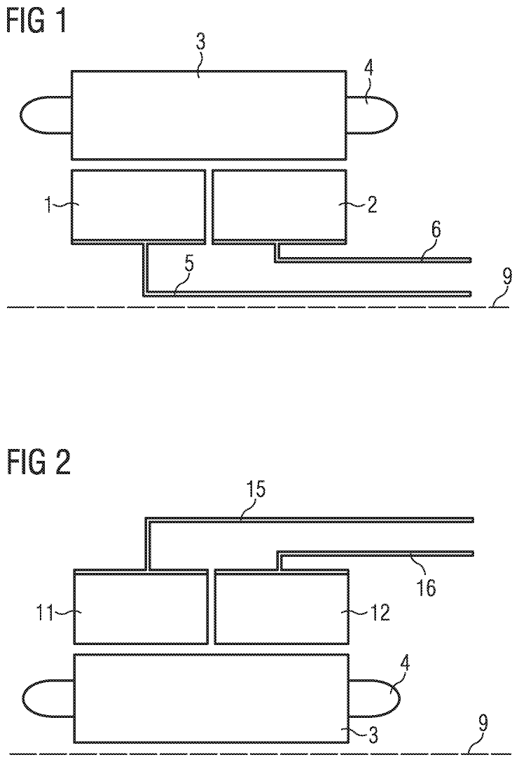

FIG. 1 an example embodiment of an electric machine according to the proposed principle,

FIG. 2 a different example embodiment of an electric machine according to the proposed principle,

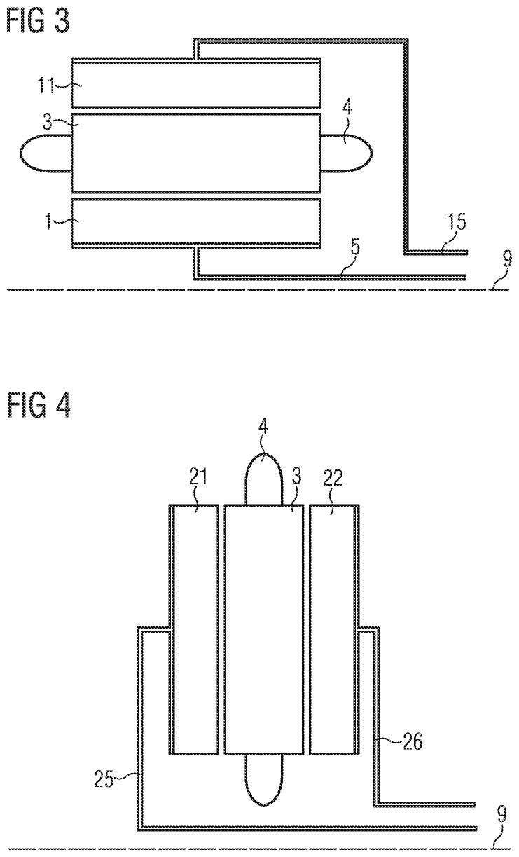

FIG. 3 a further embodiment of an electric machine according to the proposed principle,

FIG. 4 another further example embodiment of an electric machine according to the proposed principle,

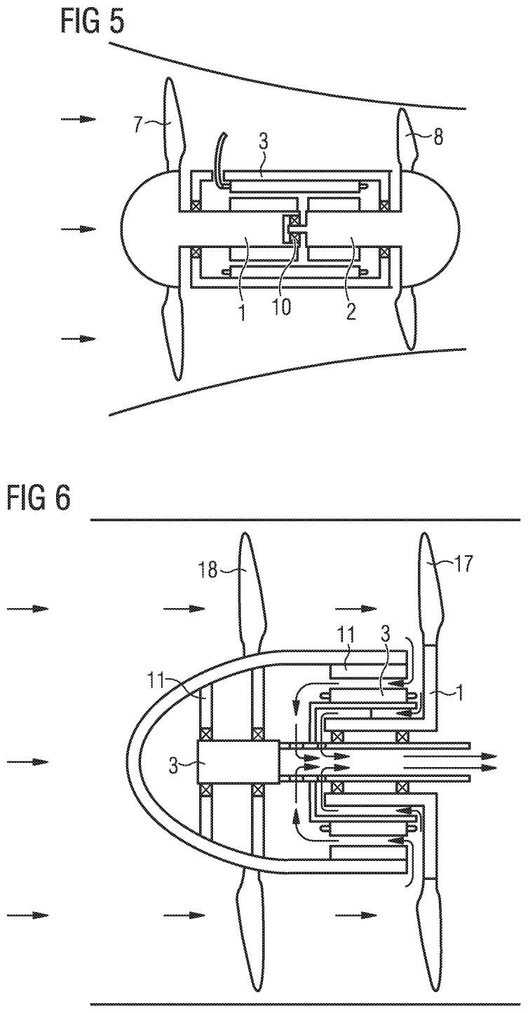

FIG. 5 an example of a drive system according to the proposed principle,

FIG. 6 a further embodiment example of a drive system according to the proposed principle,

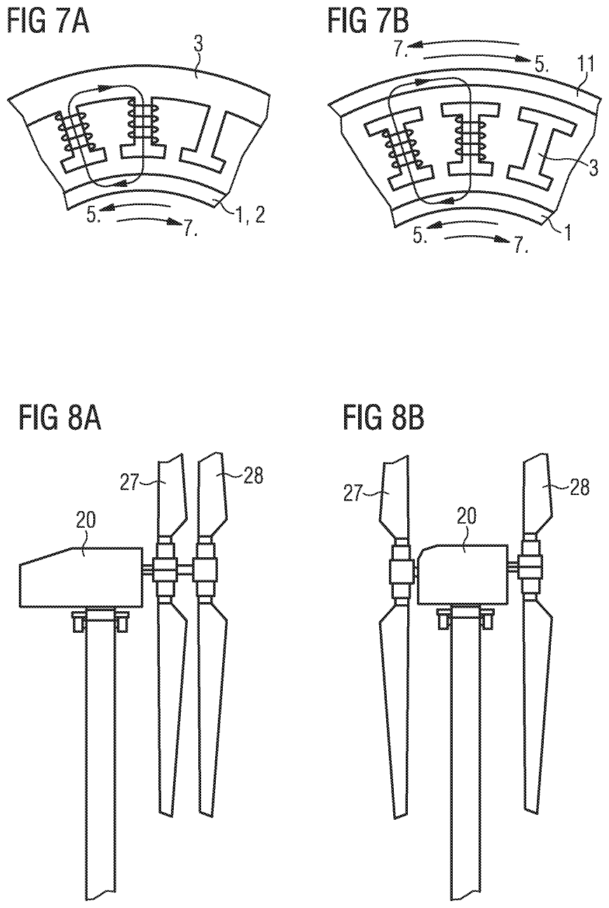

FIGS. 7A and 7B examples of tooth-concentrated windings,

FIGS. 8A and 8B examples of wind power generators having a drive system according to the proposed principle,

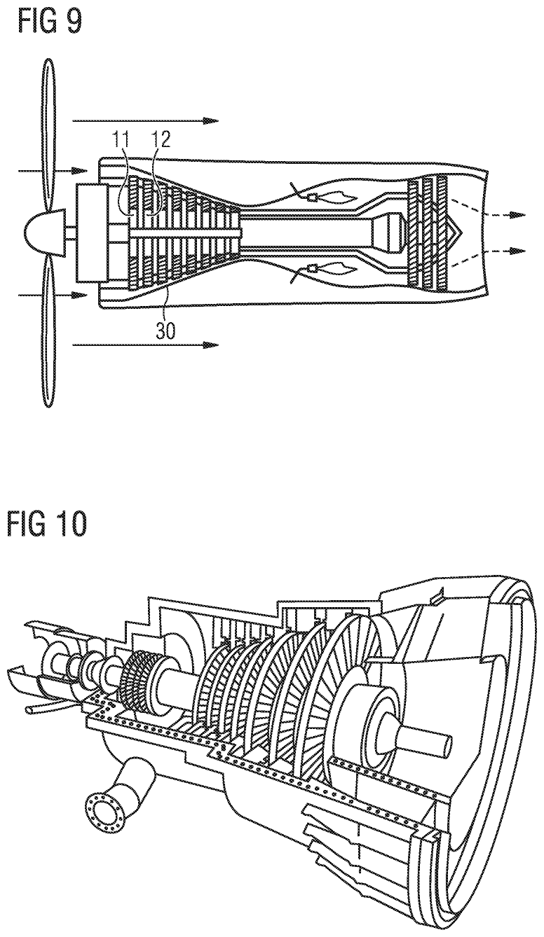

FIG. 9 an example of an aircraft drive according to the proposed principle, and

FIG. 10 an example gas and steam turbine having a drive system according to the proposed principle.

FIG. 1 shows an electric machine having a first, inner rotor 1 and rotor 2, also inner, disposed axially thereto. The two rotors 1, 2 comprise a common stator 3 on the outside relative to the axis of rotation 4 and covering both the first and the second rotor 1, 2 in the axial direction and, in the present example, having the same length as the sum of the rotors. The head of an electrical winding 4 can be seen at each of the end faces of the stator 3. Because the rotors 1, 2 have different rotary speeds and/or different direction of rotation, said rotors are attached to different shafts. The first rotor 1 is attached to a first shaft 5. The second rotor 2 is attached to a second shaft 6.

The axis of rotation 9 of the machine is also an axis of symmetry, whereby FIG. 1 shows only a cross section of the electric machine up to the axis of rotation 9.

The complete machine is axially symmetrical about the axis of rotation 9.

The common stator 3 is connected to a control unit, not shown, for feeding the winding 4.

The winding 4 comprises at least one electrical coil, not visible in the figure, disposed so that the magnetic field thereof is used by both rotors 1, 2.

Further details on the control and operating principle of the electric machine are discussed below.

FIG. 2 shows a different embodiment example of a proposed electric machine. In contrast to FIG. 1, the rotors 11, 12 are disposed on the outside. This means that said rotors have a greater radius relative to the axis of rotation 9 than the stator 3. The rotors 11, 12 together have the same axial extent as the stator 3, just as in the preceding example. The rotors 11, 12 are connected in turn to different shafts 15, 16 and rotate at different rotary speeds. FIG. 2 also shows only part of a cross section of the electric machine, namely up to the axis of rotation 9.

FIG. 3 shows an embodiment example of an electric machine having an inner rotor 1 and an outer rotor 11. A stator 3 is provided between said rotors and supports an electrical winding 4. Because the rotors 1, 11 are operated at different rotary speeds and/or direction of rotation, said rotors are each connected to different mechanical shafts 5, 15.

FIG. 4 shows a further embodiment. The present embodiment is an axial flux machine having an inner stator 3 and two outer rotors 21, 22. Because the rotors 21, 22 are operated at different rotary speeds and/or direction of rotation, said rotors are connected to different mechanical shafts 25, 26.

The embodiment according to FIG. 4 also comprises an axis of rotation 9. In contrast to the embodiments according to FIGS. 1 through 3, wherein the air gap between the rotors and the stator runs parallel to the axis of rotation 9, in the axial flux machine according to FIG. 4, the air gap runs between the stator and the rotors in the radial direction.

FIG. 5 shows an embodiment example of a drive system having an electric machine according to the proposed principle. The drive system comprises the electric machine having an outer stator 3 and two inner rotors 1, 2. The inner rotors 1, 2 are disposed axially one after the other and are covered by the common stator 3, as said stator has the same axial length as the sum of the rotors. The stator 3 comprises a continuous winding.

The first rotor 1 is mechanically fixedly connected to first blades 7 and the second rotor 2 is mechanically fixedly connected to second blades 8. The rotor 1 having the blades 7 on one hand and the second rotor 2 having the second blades 8 on the other hand each form one output unit.

The flow direction of a liquid medium is marked with arrows. The first output unit 1, 7 is impinged on first by the flow. The more slowly rotating output unit 1, 7 is impinged on first by the flow of the medium and comprises larger blades than the second output unit 2, 8. The second output unit is designed for a higher rotary speed than the first output unit.

An additional advantage of the outer stator 3 is that said stator is water-cooled by means of the housing.

A bearing 10 is provided between the first and the second rotor 1, 2 and enables the first and the second rotors 1, 2 to rotate at different rotary speeds and/or different direction of rotation and nevertheless to have the same axis of rotation.

FIG. 6 shows another embodiment of a drive system having an electric machine according to the proposed principle, here for a gaseous medium, for example in an aircraft drive. The stator 3 here is combined with an inner rotor 1 and an outer rotor 11. The inner rotor 1 is mechanically fixedly connected to first blades, while the outer rotor 11 is mechanically fixedly connected to second blades 18. The first and second blades 17, 18 have the same geometry in the present case.

The second blades of the outer rotor 11 are impinged on first by the flow in the present case.

In alternative embodiments, it is also possible that the propeller first impinged on by the flow is mounted on the inner rotor and the rear propeller on the outer rotor. This can facilitate the guiding of the cooling air.

In the present example according to FIG. 6 as well, part of the impinging air is deflected through the electric machine for cooling the same. The infeed of cooling air can be improved by means of additional vanes.

Alternatively, a drive system having rotors disposed axially one after the other, as in FIG. 5, can also be used for the medium of air.

The embodiment according to FIG. 6 is particularly well suited for aircraft drives or helicopter drives. The arrangement can also be rotated by 90° in order to thereby drive electric drones, for example.

FIG. 7 shows an example of the operating principle of the electric machine, such that the rotors are operated at different rotary speeds and/or direction of rotation.

FIG. 7A shows an example of a stator 3 having two inner rotors 1, 2, wherein here a section orthogonal to the axis of rotation is shown using a segment, wherein the rotors 1, 2 are disposed directly one after the other or one over the other. It is evident that the stator 3 comprises tooth-concentrated windings about the teeth of the stator. In the present case, the stator comprises twelve teeth, wherein each tooth is wound, wherein teeth are shown as examples in FIG. 3.

The number of poles can thus be 10 and 14, so that a rotary speed ratio of five to seven is implemented. Note that the working waves in the present case rotate in opposite directions to each other. Accordingly, the rotors in the present example have not only different rotary speeds, namely a rotary speed ratio of five to seven, but also have a different direction of rotation.

FIG. 7B in turn shows the stator 3 having tooth-concentrated windings, but here having one inner rotor 1 and one outer rotor 11. It is evident that here again the rotors are operated at a rotary speed ratio of five to seven and comprise opposite directions of rotation, wherein a reversal of direction of rotation of the two rotors is also possible, depending on the direction of rotation of the overall machine, wherein said rotors nevertheless always run in opposite directions to each other at different rotary speeds.

FIGS. 8A and 8B show embodiments of drive systems having an electric machine according to the proposed principle in an embodiment as a wind power generator. Two rotors are each disposed axially one after the other on the nacelle 20 of the wind power generator, in which the stator of the electric machine is present, and first and second blades 27, 28 are mounted on said rotors. The structure in FIGS. 8A and 8B corresponds to that of FIGS. 5 and 6, for example.

While the rotors in FIG. 8A are disposed one after the other on one side of the nacelle, in FIG. 8B one rotor each is provided on each side of the nacelle, wherein the rotors here are disposed opposite each other.

It is additionally advantageous that the second propeller comprising the second blades 28 is able to unswirl the vorticity of the air flow arising from the first propeller. This results in a largely laminar air flow, causing less noise emission.

FIG. 9 shows a different embodiment example of a drive system having an electric machine according to the proposed principle, used in an electrical or hybrid-electrical turbine or a turbojet. In the region of the compressor 30, a plurality of rotors connected axially one after the other and having corresponding blades can be seen, and said rotors alternately run in opposite directions and optionally at different rotary speeds.

The air flow in the compressor portion of the turbojet is thereby optimized and the overall efficiency of the system is increased. The rotors in the compressor are, in the present case, implemented having a common, inner stator, wherein all eight rotors in the present case are outer rotors of the common stator.

Another further embodiment example is shown in FIG. 10, in which a multi-motor generator system is shown, for example for an electrical gas and steam turbine in power plants. Here again a common, inner stator is provided, and rotors connected one after the other in the axial direction and implemented as outer rotors interact with said stator. The rotors rotate alternately opposite each other and optionally at different rotary speeds. Vane are attached to each rotor. The air flow is thereby optimized and the overall efficiency of the system is increased.

In one embodiment, not show here in any figure, a wound stator having at least one winding on at least one stator tooth having a three-phase sinusoidal feed is provided. The currents and voltages are thereby phase-offset by 120°.

Alternatively, systems having other phase numbers can be provided, wherein the phase offset in each case is then 360° divided by the number of phases. The electrical feed can not only be sinusoidal, but also supersinusoidal, rectangular, triangular, trapezoidal, or a function of the superposition of said shapes.

If, for example, a stator having three teeth is provided, wherein each tooth is wound, then the number poles can be 2, 4, 6, etc. Rotary speed ratios of 1:2, 1:3, 2:3, etc. can thus be implemented.

If a stator having twelve teeth is selected, wherein each tooth or every second tooth is wound, then the number poles can be 10 and 14. A rotary speed ratio of 5:7 can be implemented here, for example.

Of course, a multiple of the teeth, the number of poles, and the speed ratios can also be implemented.

Instead of tooth-concentrated wound coils, stator bars can also be used.

We claim:

1. An electric machine, comprising
a first rotor,
a second rotor,
a common stator,
the rotors being disposed axially to each other, and
the rotors being set up for different rotary speeds and/or direction of rotation.

2. The electric machine according to claim 1,
wherein the common stator comprises at least one electrical coil disposed so that the magnetic field thereof is used by both rotors.

3. The electric machine according to claim 2,
the stator thereof comprising a tooth-concentrated winding having at least one electrical coil.

4. The electric machine according to claim 1,
wherein the common stator comprises at least one groove, in which an axially disposed conductor bar is placed, such that the magnetic field so generated is used by both rotors.

5. The electric machine according to claim 4,
wherein a plurality of conductor bars are distributed in axial grooves along the circumference of the stator and the conductor bars are fed by one electrical phase each.

6. The electric machine according to claim 1,
implemented such that the magnetomotive force in the air gap between the stator and the rotors has at least two higher harmonics, of which one is used as a working wave for the first rotor and the other is used as a working wave for the second rotor.

7. The electric machine according to claim 1,
comprising more than two rotors.

8. The electric machine according to claim 1,
comprising an even number of rotors.

9. The electric machine according to claim 1,
wherein the rotors comprise at least one of the following types: synchronous rotor, rotor having surface magnets, rotor having buried magnets, synchronous reluctance rotor, externally excited synchronous rotor.

10. A drive system having an electric machine according to claim 1, for use in liquid or gaseous media,
wherein the first rotor is mechanically connected to first blades and the second rotor is mechanically connected to second blades.

11. The drive system according to claim 10,
wherein the first blades are implemented as a propeller or impeller and wherein the second blades are implemented as a propeller or impeller.

12. The drive system according to claim 10 or 11,
wherein the first blades have a different geometry from the second blades.

13. The drive system according to claim 10 or 11,
wherein the more slowly rotating rotor comprises blades having a larger diameter.

14. The drive system according to claim 10 or 11,
wherein the output unit rotating more slowly is impinged on first by the liquid or gaseous medium.

15. The drive system according to claim 10 or 11,
comprising a rotationally symmetrical housing comprising circular openings for the liquid or gaseous medium to flow in and out.

16. The drive system according to claim 10 or 11,
wherein the rotationally symmetrical housing comprises a streamlined contour in the axial direction, for example in the form of a Venturi nozzle.

17. A use of the drive system according to claim 10 or 11 in at least one of the following:
pump drive, compressor drive, wind power generator, drive for watercraft, drive for aircraft.
